(19) United States
(12) Patent Application Publication
(10) Pub. No.: US 2010/0186302 A1
(43) Pub. Date: Jul. 29, 2010

(54) REGENERATING PROCESS AND REGENERATING SYSTEM TO REGENERATE WASTE SLURRY FROM SEMI-CONDUCTOR WAFER MANUFACTURING PROCESS

(76) Inventors: Seoung Young Lim, Chungcheongnam-do (KR); Sung Shin Kim, Chungcheongnam-do (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/663,333

(22) PCT Filed: Mar. 20, 2008
(86) PCT No.: PCT/KR08/01577

§ 371 Date: Apr. 1, 2010

(30) Foreign Application Priority Data
Jun. 15, 2007 (KR) 10-2007-0058909

(51) Int. Cl. C09K 3/14; C09C 1/68; G05D 9/00; B01F 13/00; B04B 11/00; B01J 19/00; C09C 1/28

(52) U.S. Cl. 51/307; 422/106

(57) ABSTRACT

There are provided a method and a system for regenerating a waste slurry which is disused after a slurry has been used to raise the cutting efficiency in a process of fabricating various wafers, such as semiconductor wafers, solar wafers and others. The method for regenerating the waste slurry processes comprises: a waste slurry mixing step (S10) of mixing a waste slurry, to disperse abrasives and chips contained in the waste slurry; a dispersing step (S20) of dispersing the waste slurry mixed in the mixing step, by using ultrasonic waves; a centrifuging step (S30) of extracting abrasive solids from the waste slurry dispersed in the dispersing step, by using a centrifuge; an abrasive solid mixing step (S40) of mixing the abrasive solids extracted in the centrifuging step; an abrasive purifying step (S50) of purifying the abrasives mixed in the mixing step, by using an abrasive purifier; a drying step (S60) of removing moisture of the abrasive solids purified in the abrasive purifying step; and a regenerating step (S70) of processing the abrasives dried in the drying step, to be in a powder state. The system for regenerating a waste slurry made during various wafer fabrication processes comprises: a waste slurry mixer (10) for mixing a waste slurry being put into the mixer (10), to scatter a precipitate composed of abrasives and chips included in the waste slurry; a particle disperser (20) for dispersing the mixed waste slurry flowing from the mixer (10), by using ultrasonic waves; a centrifuge (30) for centrifuging the waste slurry dispersed by the particle disperser (20), to extract the abrasives; a number of sub-tanks (40) for storing the abrasives extracted by the centrifuge (30); a number of mixers (50) for mixing the abrasives of the sub-tanks (40); a number of abrasive purifiers (60), each including a cleaning device installed in the centrifuge, for removing impurities remaining on the abrasives by receiving the abrasives supplied from the mixers (50); a drier (70) for drying the abrasives purified by the abrasive purifiers (60); and an abrasive powder maker (80) for regenerating the abrasives dried by the drier (70).

### TECHNICAL FIELD

The present invention relates to a method and a system for regenerating a waste slurry which is disused after a slurry is used to raise the cutting efficiency in a process of fabricating various wafers, such as semiconductor wafers, solar wafers and others.

### BACKGROUND ART

In general, a waste slurry made during a semiconductor fabrication process is composed of an oil-soluble cutting fluid, silicon (chips: Si) which is a material of a silicon wafer, silicon carbide (abrasives: SiC) and scraps of copper wire and the like used for cutting in the form of powder being about 10 μm or less. Meantime, the waste slurry composed of the aforementioned mixture would be stored for several months if short or one to two years if long and thereafter would be burned up or buried.

However, there have been presented diverse technologies to regenerate a waste slurry made during a semiconductor fabrication process and the like, for reuse, to decrease a unit cost of producing a semiconductor wafer and to prevent environmental pollution caused by the disposal of the waste slurry classified as industrial waste through the destruction by fire or landfill.

Examples of the technologies presented to regenerate the waste slurry include Korean Patent Registration No. 393007 (entitled: Method and system for regenerating waste slurry made during semiconductor wafer fabrication process), Korean Laid-Open Publication Patent No. 10-2004-0055218 (entitled: Method for manufacturing high purity silicon carbide from waste semiconductor slurry), and others.

The method for regenerating a waste slurry made during a semiconductor wafer fabrication process, which is disclosed in Korean Patent Registration No. 393007 (entitled: Method and system for regenerating waste slurry made during semiconductor wafer fabrication process), comprises: a mixing step of mixing a waste slurry, to scatter a precipitate formed of abrasives and chips; a dilution step of mixing a regeneration oil and the waste slurry mixed in the mixing step, to dilute the waste slurry; a first centrifugation step of firstly centrifuging the waste slurry in the dilution step, to extract the abrasives from the waste slurry; a second centrifugation step of secondarily centrifuging a first oil obtained by being firstly centrifuged in the first centrifugation step, to separate a second oil and the chips from the first oil; a filtering/purifying step of filtering the second oil to be purified, to be restored to the regeneration oil; and a waste slurry regeneration step of regenerating the slurry by adding the abrasives extracted in the first centrifugation step to the regeneration oil purified in the filtering/purifying step.

The system for regenerating a waste slurry made during a semiconductor wafer fabrication process comprises: a mixing tank of mixing a waste slurry being put into the mixing tank, to scatter a precipitate formed of abrasives and chips included in the waste slurry; a dilution tank of diluting the mixed waste slurry flowing from the mixing tank, by mixing a regeneration oil with the waste slurry; a first centrifuge of firstly centrifuging the diluted waste slurry flowing from the dilution tank, to extract the abrasives; a second centrifuge of secondarily centrifuging a first oil, which is obtained as a result of extracting the abrasives by first centrifuging the diluted waste slurry, and the chips; a filter of filtering/purifying a second oil which is obtained as a result of extracting the chips by the second centrifuge, to produce the regeneration oil; and a readjustment tank of regenerating a regeneration slurry by adding the abrasives extracted by the first centrifuge to the regeneration oil purified and regenerated by the filter.

In the aforementioned method and system for regenerating the waste slurry made during the semiconductor wafer fabrication process, when the mixer is used to scatter the waste slurry being solidified due to a long period of storage, since the abrasives and impurities stuck to the abrasives are not dispersed, the impurities are stuck to the abrasives extracted by the centrifuge. Consequently, the conventional art has the problem in that high purity abrasives cannot be extracted.

### DISCLOSURE OF INVENTION

### Technical Problem

Therefore, the present invention has been made to solve the above problems, and it is an object of the present invention to obtain pure abrasives by preventing any foreign materials from being included in the abrasives extracted by a centrifuge, by mixing a solidified waste slurry by a mixer and dispersing the mixed waste slurry by a particle disperser using ultrasonic waves.

Another object of the present invention is to provide a particle disperser of dispersing a waste slurry by using ultrasonic waves.

Another object of the present invention is to obtain pure abrasives by providing an abrasive purifier with a cleaning device to a centrifuge.

### Technical Solution

In accordance with an aspect of the present invention, the above and other objects can be accomplished by a method for regenerating a waste slurry made during a semi-conductor wafer fabrication process using a centrifuge, which comprises: a waste slurry mixing step of mixing a waste slurry by a mixer so that abrasives and chips contained in the waste slurry are dispersed; a dispersing step of dispersing the waste slurry mixed in the mixing step by a particle disperser using ultrasonic waves; a centrifuging step of centrifuging the waste slurry dispersed in the dispersing step so that the abrasives are extracted by a centrifuge; an abrasive solid mixing step of mixing abrasive solids (SiC cake) extracted in the centrifuging step by a mixer; an abrasive purifying step of purifying the abrasives mixed in the mixing step by an abrasive purifier; a drying step of removing moisture of the abrasive solids (SiC cake) purified in the abrasive purifying step; and a regenerating step of processing the abrasive solids (SiC cake) dried in the drying step to be in a powder state.

The mixing step of mixing the abrasive solids (SiC cake) purified in the abrasive purifying step by the mixer and the abrasive purifying step of purifying the abrasives mixed in the mixing step by the abrasive purifier may be further repeatedly performed two to six times.

A sub-tank for temporarily storing the abrasives may be further installed between the mixer used in the mixing step and the abrasive purifier used in the abrasive purifying step.

In accordance with another aspect of the present invention, the above and other objects can be accomplished by a system for regenerating a waste slurry made during a semiconductor wafer fabrication process, using a centrifuge, which comprises: a waste slurry mixer for mixing a waste slurry being put into the waste slurry mixer so that a precipitate composed of abrasives and chips contained in the waste slurry is mixed; a particle disperser for dispersing the mixed waste slurry flowing from the mixer, by ultrasonic waves; a centrifuge for centrifuging the waste slurry waste dispersed by the particle disperser, to extract the abrasives; a number of mixers for mixing abrasive solids extracted by the centrifuge; a number of abrasive purifiers, each having a cleaning device installed in the centrifuge, for receiving the abrasive solids supplied from the mixer and removing impurities remaining on the abrasives; a drier for removing moisture of the abrasive solids purified by the abrasive purifiers; and an abrasive powder maker for regenerating the abrasives dried by the drier.

The system may further comprise: a number of sub-tanks for temporarily storing the abrasive solids extracted by the centrifuge and the abrasive purifiers.

The particle disperser formed to store the supplied waste slurry may comprise: a storage tank with an input opening formed at an upper part of the storage tank and an outlet formed at a lower part thereof, wherein the input opening allows the waste slurry to flow into the storage tank and the outlet allows the dispersed waste slurry to flow out; a ultrasonic generator for generating the ultrasonic waves to disperse the waste slurry stored in the storage tank, wherein the ultrasonic generator includes lateral vibrators positioned at both sides inside the storage tank, a lower vibrator positioned at a lower side thereof, and oscillators each connected to the vibrators; a mixing device for mixing the waste slurry stored in the storage tank; a level sensor for sensing a water level of the waste slurry inside the storage tank; a temperature sensor for measuring a temperature of the waste slurry; and a control unit for controlling the above-described constituents.

### Advantageous Effects

The system for regenerating the waste slurry made during the semiconductor wafer fabrication process, which uses the centrifuge, has the effect of obtaining high purity abrasives by dispersing the waste slurry by use of the particle disperser using the ultrasonic waves.

Further, since the vibrators generating the ultrasonic waves are positioned in the opening at a lower part of the particle disperser, and the outlet allowing the dispersed waste slurry to flow out is formed at one side of the opening, the effectively dispersed waste slurry is supplied to the centrifuge, to increase the purity of the abrasives extracted by the centrifuge.

Further, the abrasive purifier including the cleaning device installed at the centrifuge has the effect of increasing the purity of the extracted abrasives.

### BRIEF DESCRIPTION OF THE DRAWINGS

These and/or other aspects and advantages of the present invention will become apparent and more readily appreciated from the following description of the embodiments, taken in conjunction with the accompanying drawings, in which:

FIG. 1 is a flow chart of a method for regenerating waste slurry according to a preferred embodiment of the present invention;

FIG. 2 is an arrangement view of a system for regenerating waste slurry according to another preferred embodiment of the present invention;

FIG. 3 is a front view of a particle disperser according to another preferred embodiment of the present invention;

FIG. 4 is a side view of the particle disperser according to the preferred embodiment of the present invention;

FIG. 5 is a front view of a centrifuge according to another preferred embodiment of the present invention; and

FIG. 6 is a front view of an abrasive purifier according to another preferred embodiment of the present invention.

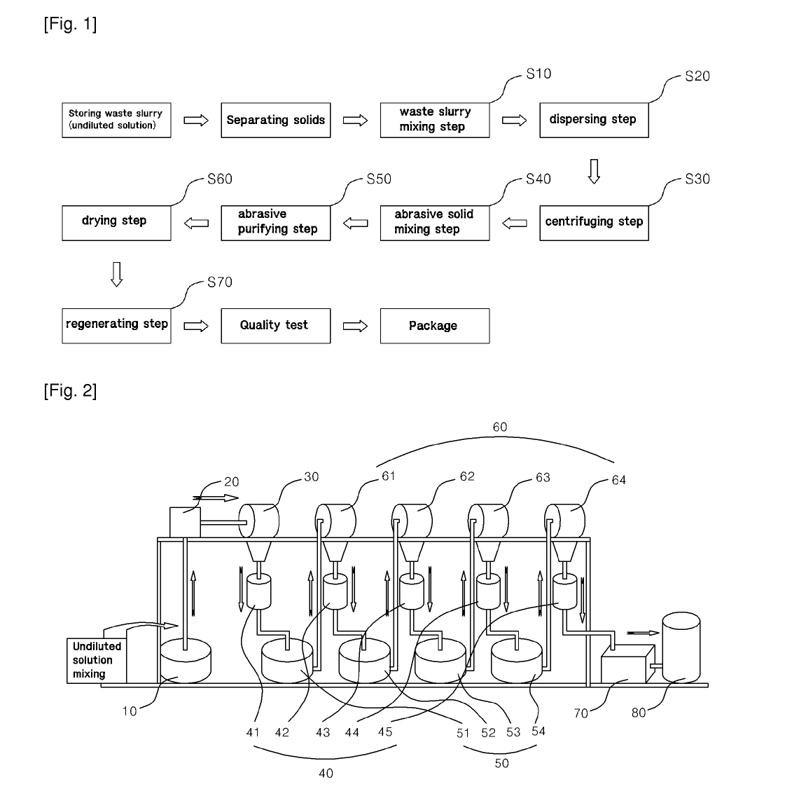

### EXPLANATION ON ESSENTIAL ELEMENTS OF DRAWINGS

S10: Waste slurry mixing step S20: Dispersion step

S30: Centrifugation step S40: Abrasive solid mixing step

S50: Abrasive purifying step S60: Drying step

S70: Regenerating step

10,50: Mixer 20: Particle disperser

30: Centrifuge 40: Sub-tank

60: Abrasive purifier 70: Drier

80: Powder maker

### MODE FOR INVENTION

A method and a system for regenerating a waste slurry made during a semiconductor wafer fabrication process will now be described more fully hereinafter with reference to the accompanying drawings, in which preferred embodiments of the present invention are shown.

This invention may, however, be embodied in many different forms and should not be construed as being limited to the embodiments set forth herein. Rather, these embodiments are provided so that this disclosure will be thorough and complete, and will fully convey the scope of the invention to those skilled in the art.

In general, the waste slurry made during a semiconductor fabrication process is stored in a PE container of one cubic meter, and after a long period of storage, it is supplied to a regeneration company.

As the waste slurry is stored in the container for a long time, solids of abrasives and chips precipitate in a bottom of the container. The solids precipitating in the bottom of the container are separated from the container by heating the solids at about 35° C. using a movable heater and mixing the solids using a mixer.

The waste slurry separate from the container is supplied to a system for regenerating the waste slurry made during a semiconductor wafer fabrication process as illustrated in FIG. 2, to be regenerated.

As illustrated in FIG. 2, using a centrifuge, the system for regenerating a waste slurry made during a semiconductor wafer fabrication process comprises: a waste slurry mixer 10 for mixing a waste slurry being put into the mixer 10 so that a precipitate composed of abrasives, chips and the like contained in the waste slurry is dispersed; a particle disperser 20 for dispersing the mixed waste slurry flowing from the mixer 10 by ultrasonic waves; a centrifuge 30 for centrifuging the waste slurry waste dispersed by the particle disperser 20, to extract the abrasives; a number of sub-tanks 40 for temporarily storing abrasive solids extracted from the centrifuge 30 or an abrasive purifier 60 to be described later; a number of mixers 50 for mixing the abrasives of the stub-tanks 40; a number of abrasive purifiers 60, each having a cleaning device installed in the centrifuge, for receiving the abrasives supplied from the mixers 50 and removing impurities remaining on the abrasives; a drier 70 for drying the abrasive solids purified by the abrasive purifiers 60; and an abrasive powder maker 80 for regenerating the abrasive dried in the drier 70.

Specifically, a number of the sub-tanks 40, a number of the mixers 50 and a number of abrasive purifiers 60 are arranged so that the abrasives mixed in the mixers can be purified by the abrasive purifiers two to six times (see FIG. 2).

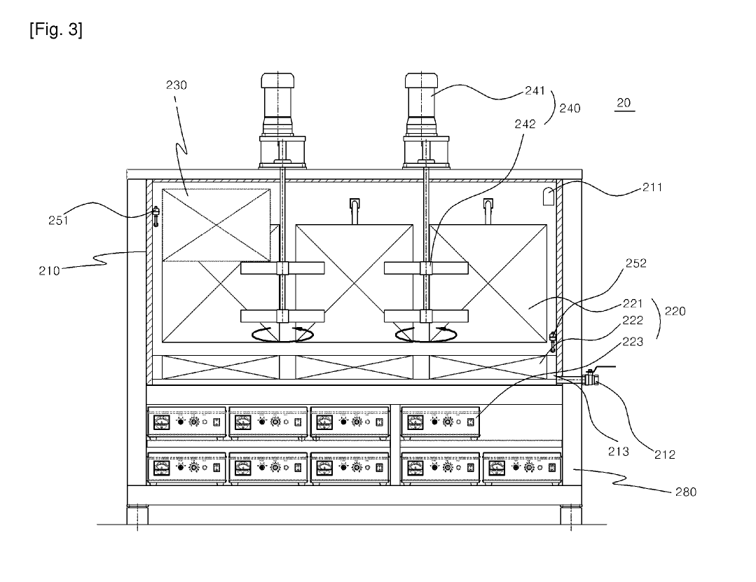

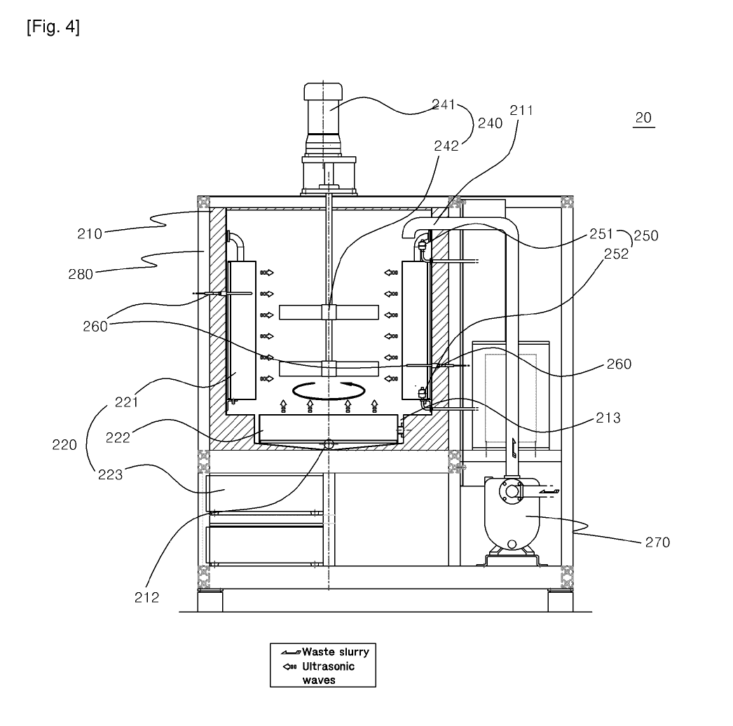

In the particle disperser 20, a number of vibrators for generating ultrasonic waves are installed inside a storage tank in which the waste slurry is stored. The vibrators are positioned at sides and a lower side of the storage tank, to accurately disperse the abrasive and chip particles. Further, in the particle disperser 20, a mixing device for mixing the waste slurry is installed, so that the particles of the waste slurry are more accurately dispersed by the ultrasonic waves and the mixing. The waste slurry discharged from the particle disperser is dispersed by the ultrasonic waves until the moment of discharging by the vibrator installed at the lower side. FIGS. 3 and 4 illustrate schematic sectional views of the particle disperser 20 applied to the system for regenerating the waste slurry according to the embodiment of the present invention.

The particle disperser 20, which is formed to store the supplied waste slurry, as illustrated in FIGS. 3 and 4, comprises: a storage tank 210 including an input opening 211 formed at an upper part of the storage tank 210 and an outlet 212 formed at a lower part thereof, wherein the input opening 211 allows the waste slurry to flow into the storage tank 210 and the outlet 212 allows the dispersed waste slurry to flow out; a ultrasonic generator 220 for generating the ultrasonic waves to disperse the waste slurry stored in the storage tank 210, wherein the ultrasonic generator 220 includes lateral vibrators 221 positioned at both sides inside the storage tank 210, a lower vibrator 222 positioned at a lower side thereof, and oscillators 223 each connected to the vibrators 221 and 222; a mixing device 240 for mixing the waste slurry stored in the storage tank 210; a number of level sensors 250 for sensing a water level of the waste slurry inside the storage tank 210; a temperature sensor 260 for measuring a temperature of the waste slurry; a control unit 230 for controlling the above-described constituents; and a frame 280 for supporting the constituents.

The level sensor 250 may be more than one, to control the vibrators by sensing the accurate water level of the waste slurry and two to five level sensors may be installed.

Specifically, the lower vibrator 222 is installed inside an opening 213 formed at the lower side of the storage tank 210. The outlet 212 is formed at one side of the opening 213, so that the waste slurry flowing out through the outlet 212 is dispersed by the ultrasonic waves.

In the particle disperser 20, the waste slurry dispersed by the miser 10 is stored through the input opening 211 of the storage tank 210 through a waste slurry supply pump 270, and when the waste slurry being as much as the capacity of the storage tank 210 flows into the storage tank 210, the control unit 230 stops the supply pump 270 to discontinue the supply of the waste slurry and uses the ultrasonic generator 220 to generate the ultrasonic waves to disperse the waste slurry. Then, to prevent the waste slurry being present the middle of the storage tank 210 from being not dispersed or slowly dispersed because the ultrasonic waves are not sufficiently transferred, the mixing device 240 is used to mix the waste slurry. The temperature of the waste slurry dispersed by the ultrasonic waves generated in the ultrasonic generator 220 goes up. Then, the temperature sensor 260 measures the rising temperature of the waste slurry and the control unit 230 allows the dispersed waste slurry to flow out through the outlet 212, depending on the measured temperature. When the dispersed waste slurry flows out through the outlet 212, the water level of the waste slurry in the storage tank 210 becomes low. Then, a lateral vibrator level sensor 251 and a lower vibrator level sensor 252 as the level sensor 250 sense the lowering water level of the waste slurry, and the control unit 230 stops the vibrators 221 and 222 of the ultrasonic generator 220 in turn, based on the signals transferred from the level sensor 250.

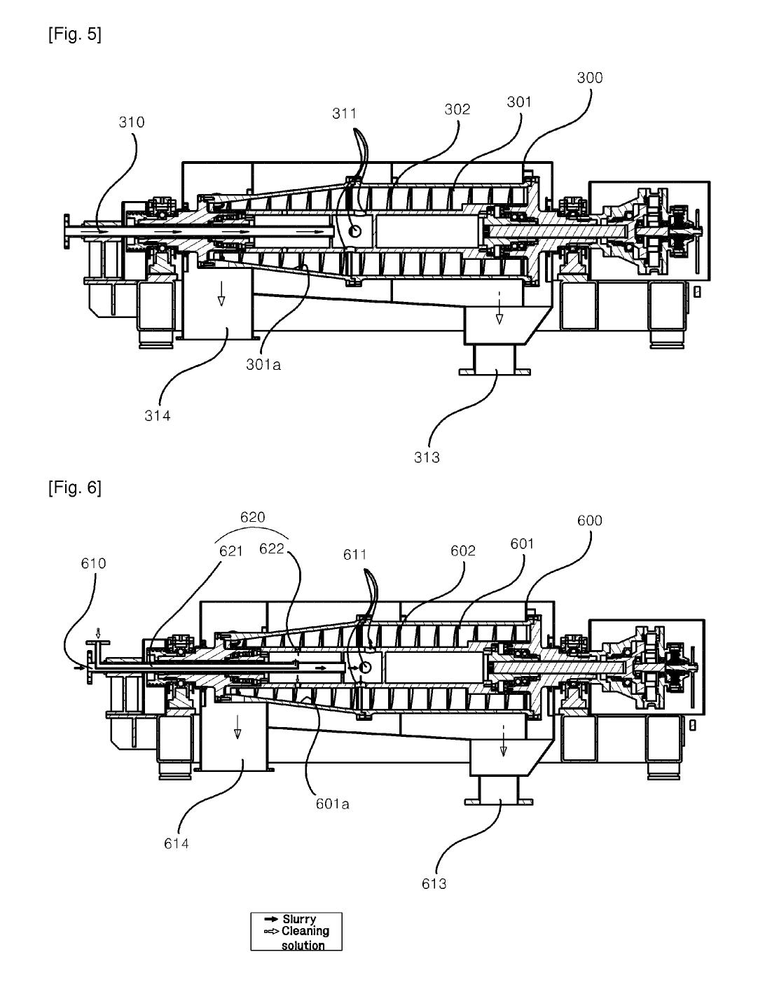

As a machine applying ordinary techniques and devices of centrifuging particles and having the same operation principles thereof, the centrifuge 30 is constituted to separate two materials from the mixture thereof, using a difference of gravity. FIG. 5 illustrates a schematic section view of the centrifuge 30 applied to the system for regenerating a waste slurry according to the embodiment of the present invention.

The centrifuge 30 comprises a housing 300, an inner shell 301 built in the housing 300, and a spiral screw 302 installed in the inner shell 301. The waste slurry flows in through a supply path 310 formed inside the screw 302 and flows out through an outlet 311. In the screw 302 rotated by a motor (not shown), the abrasives having relatively great gravity, which are contained in the waste slurry, are transferred in a direction of a progressively reducing width of the screw 302 so that the abrasives flow out through a first outlet 314 formed at a lower position, and the chips and cutting oil having relatively small gravity are transferred in the opposite direction so that the chips and cutting oil flow out through a second outlet 313 formed at an end of the screw 302 which is broader in width.

The sub-tank 40 temporarily stores the abrasive solids extracted from the waste slurry. When a part of the constituents of the system for regenerating the waste slurry is not normal, the sub-tank 40 offers time to enable the continuity of the system for regenerating the waste slurry. Inside the sub-tank 40, a vibrator (not shown) is installed to smoothly flow out the abrasive solids stored therein.

The abrasive purifier 60 includes a pipe formed to supply a cleaning solution to a conventional centrifuge, and a cleaning solution outlet formed to supply the cleaning solution to the abrasive solids which are pushed by the screw and come up along an inclined plane. The supplied cleaning solution cleans the chips which are present on the top of the extracted solids, so that high purity abrasives are extracted. FIG. 6 illustrates a schematic sectional view of the abrasive purifier 60 applied to the system for regenerating the waste slurry according to the embodiment of the invention.

The abrasive purifier 60, which is formed in the same structure as the centrifuge 30 described above, further comprises a cleaning device 620 including an input tube 621 and a cleaning solution outlet 622. The input tube 621 for putting the cleaning solution is installed in a supply path 610 formed to supply an undiluted solution (the waste slurry) to the inside of a screw 602, and the cleaning solution outlet 622 is installed to supply the cleaning solution supplied from the input tube 621 to the extracted abrasive solids which are pushed up along an inclined plane 601a of an inner shell by the screw 602.

The mixer 50 mixes the abrasive solids (SiC cake) extracted by the centrifuge 30 or the abrasive purifier 60 with the cleaning solution or cleaning water to be in a slurry state, separates and dissolves iron, silicon and other foreign materials remaining in the slurry solution, and simultaneously more effectively separates the chips remaining on the surface of the abrasives by the mixing.

The drier 70 for removing moisture of the abrasive solids (SiC cake) purified and extracted by the abrasive purifier 60 generally uses a batch type tunnel firing furnace of about 500° C.

The abrasive powder maker 80 is to make the abrasive solids (SiC cake) from which the moisture is removed by the drier 70 in a powder state. The abrasive powder maker 80 makes the abrasive solids (SiC cake) in the powder state, by rotating a rotation blade at about 1000 rpm in a batch tank in which the rotation blade is installed.

Using the system for regenerating the waste slurry made during the semiconductor wafer fabrication process according to the embodiment of the present invention, a method for regenerating the waste slurry made during the semiconductor wafer fabrication process is carried out by the following sequences:

1. Waste Slurry Mixing Step S10

When a waste slurry is separated from a waste slurry collection container (a PE container of one cubic meter) and is supplied to a mixer 10, a motor of the mixer 10 is operated so that a mixing wing mixes abrasives and chips to be separated from each other.

2. Dispersion Step S20

The mixed waste slurry is sent to a particle disperser 20 using ultrasonic waves, so that the abrasives and chips of the mixed waste slurry are effectively dispersed by the ultrasonic waves.

3. Centrifugation Step S30

The waste slurry dispersed by the ultrasonic waves is sent to a centrifuge 30, so that abrasive solids are extracted by centrifugation.

Since the abrasives and chips are effectively dispersed in the waste slurry dispersed by the ultrasonic waves, the purity of the abrasive solids extracted by the centrifuge 30 increases.

The abrasive solids extracted by the centrifuge 30 are temporarily stored in a first sub-tank 41.

4. Abrasive Solid Mixing Step S40

The abrasive solids extracted by the centrifuge 30 and stored in the first sub-tank 41 are quantitatively supplied to a mixer, to be quantitatively supplied so as to be suitable for the capacity of an abrasive purifier to be described later.

The abrasive solids extracted by the centrifuge 30 is put into a mixing tank of a first mixer 51, together with a cleaning solution or cleaning water, so that the abrasive solids and the cleaning solution or cleaning water are mixed together in a slurry state.

5. Abrasive Purifying Step S50

The abrasives mixed in the slurry state are purified by an abrasive purifier 60. As described above, since the abrasive purifier 60 includes a cleaning device installed in the centrifuge, the chips remaining on the surface of the abrasives are removed by using the cleaning solution or cleaning water supplied to the cleaning device, so that high purity abrasive solids are produced.

The abrasives mixed in the slurry state by the first mixer 51 are purified by a first abrasive purifier 61 and subsequently the purified abrasive solids are temporarily stored in a second sub-tank 42.

6. Abrasive Solid Mixing Step S40

The abrasive solids extracted by the first abrasive purifier 61 and stored in the second sub-tank 42 are put into a mixing tank of a second mixer 52, together with the cleaning solution or cleaning water, so that the abrasive solids and the cleaning solution or cleaning water are mixed together in the slurry state.

7. Abrasive Purifying Step S50

The abrasives mixed by the second mixer 52 are purified by a second abrasive purifier 62, and the abrasive solids purified in the second abrasive purifier 62 are temporarily stored in a third sub-tank 43.

8. Abrasive Solid Mixing Step S40

The abrasive solids extracted by the second abrasive purifier 62 and stored in the third sub-tank 43 are put into a mixing tank of a third mixer 53, together with the cleaning solution or cleaning water, so that the abrasive solids and the cleaning solution or cleaning water are mixed together in the slurry state.

9. Abrasive Purifying Step S50

The abrasives mixed by the third mixer 53 are purified by a third abrasive purifier 63, and the abrasive solids purified in the third abrasive purifier 63 are temporarily stored in a fourth sub-tank 44.

10. Abrasive Solid Mixing Step S40

The abrasive solids extracted by the third abrasive purifier 63 and stored in the fourth sub-tank 44 are put into a mixing tank of a fourth mixer 54, together with the cleaning solution or cleaning water, so that the abrasive solids and the cleaning solution or cleaning water are mixed together in the slurry state.

11. Abrasive Purifying Step S50

The abrasives mixed by the fourth mixer 54 are purified by a fourth abrasive purifier 64, and the abrasive solids purified in the fourth abrasive purifier 64 are temporarily stored in a fifth sub-tank 45.

12. Drying Step S60

The abrasive solids stored in the fifth sub-tank 45 are supplied to a drier 70, to remove moisture being present on the abrasive solids.

The drier 70 includes a batch-type tunnel firing furnace and dries the abrasive solids at the temperature of about 500° C.

13. Regenerating Step S70

The abrasive solids (SiC cake) from which the moisture is removed by the drier 70 is manufactured in a powder state by an abrasive powder maker 80.

The number of performing the abrasive solid mixing step S40 and the abrasive purifying step S50 may vary according to the purity of the abrasives to be extracted, and it is generally two to six times.

Each sub-tank 40 is positioned between each mixer 50 and each abrasive purifier 60 and stores the purified abrasive solids, thereby providing time when a constituent is checked or repaired and therefore enabling a continuous process.

The system for regenerating the waste slurry made during the semiconductor wafer fabrication process according to the present invention can be used for regenerating waste slurries made under processes for fabricating solar wafers and various wafers as well as under the process for fabricating semiconductor wafers.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for regenerating a waste slurry made during a semiconductor wafer fabrication process, using a centrifuge, comprising:
a waste slurry mixing step (S10) of mixing a waste slurry by using a mixer, to disperse abrasives and chips contained in the waste slurry;
a dispersing step (S20) of dispersing the waste slurry mixed in the mixing step, by using ultrasonic waves;
a centrifuging step (S30) of extracting the abrasives from the waste slurry dispersed in the dispersing step, by using a centrifuge;
an abrasive solid mixing step (S40) of mixing abrasive solids (SiC cake) extracted in the centrifuging step, by using a mixer;
an abrasive purifying step (S50) of purifying the abrasives mixed in the mixing step, by using an abrasive purifier;
a drying step (S60) of removing moisture of the abrasive solids (SiC cake) purified in the abrasive purifying step; and
a regenerating step (S70) of processing the abrasive solids (SiC cake) dried in the drying step, to be in a powder state, and
wherein a sub-tank for temporarily storing the abrasives is installed between the mixer used in the mixing step and the abrasive purifier used in the abrasive purifying step.

2. The method according to claim 1, wherein the mixing step of mixing the abrasive solids (SiC cake) purified in the abrasive purifying step (S50) by using the mixer and the abrasive purifying step of purifying the abrasives mixed in the mixing step by using the abrasive purifier are repeatedly performed two to six times.

3. A system for regenerating a waste slurry made during a semiconductor wafer fabrication step, using a centrifuge, comprising:
a waste slurry mixer (10) for mixing a waste slurry being put into the mixer (10), to scatter a precipitate composed of abrasives and chips included in the waste slurry;
a particle disperser (20) for dispersing the mixed waste slurry flowing from the mixer (10), by using ultrasonic waves;
a centrifuge (30) for centrifuging the waste slurry dispersed by the particle disperser (20) to extract the abrasives, wherein the centrifuge (30) comprises: a storage tank (210) for storing the supplied waste slurry, the storage tank (210) including an input opening (211) formed at an upper part of the storage tank (210) and an outlet (212) formed at a lower part thereof, wherein the input opening (211) allows the waste slurry to flow into the storage tank (210) and the outlet (212) allows the dispersed waste slurry to flow out; a ultrasonic generator (220) for generating the ultrasonic waves to disperse the waste slurry stored in the storage tank (210), the ultrasonic generator (220) including lateral vibrators (221) positioned at both sides inside the storage tank (210), a lower vibrator (222) positioned at a lower side of the storage tank (210), and oscillators (223) installed to be respectively connected to the lateral vibrators (221) and the lower vibrator (222); a mixing device (240) for mixing the waste slurry stored in the storage tank (210); a level sensor (250) for sensing a water level of the waste slurry inside the storage tank (210); a temperature sensor (260) for measuring a temperature of the waste slurry; and a control unit (230) for controlling the constituents;
a number of mixers (50) for mixing abrasive solids extracted by the centrifuge (30);
a number of abrasive purifiers (60), each including a cleaning device installed in the centrifuge, for removing impurities remaining on the abrasives by receiving the abrasive solids supplied from the mixers (50);
a drier (70) for removing moisture of the abrasive solids purified by the abrasive purifiers (60); and
an abrasive powder maker (80) for regenerating the abrasives dried by the drier (70).

4. The system according to claim 3, further comprising: a number of sub-tanks (40) for temporarily storing the abrasive solids respectively extracted in the centrifuge (30) and the abrasive purifier (60).
